(19) United States
(12) Patent Application Publication
(10) Pub. No.: US 2012/0253764 A1
(43) Pub. Date: Oct. 4, 2012

(54) Method of optimising a wind park construction

(76) Inventor: Soeren E. Nielsen, Skanderborg (DK)

(21) Appl. No.: 13/431,014

(22) Filed: Mar. 27, 2012

(30) Foreign Application Priority Data
Apr. 4, 2011 (EP) EP11160969

(51) Int. Cl. G06F 17/50

(52) U.S. Cl. 703/6

(57) ABSTRACT

A method of optimising a wind park construction is provided. The wind park includes at least a first wind turbine and a second wind turbine. According to the method, a first blade topology is selected for the first wind turbine depending on a noise optimisation parameter which is measured and/or predicted at a reference position at a distance from the wind park. A second blade topology is selected for the second wind turbine depending on an energy efficiency optimisation parameter.

### CROSS REFERENCE TO RELATED APPLICATIONS

This application claims priority of European Patent Office application No. 11160969.9 EP filed Apr. 14, 2011. All of the applications are incorporated by reference herein in their entirety.

### FIELD OF INVENTION

The invention describes a method of optimising a wind park construction. The invention further describes a wind turbine for such a wind park and a wind park with such wind turbines.

### BACKGROUND OF INVENTION

A wind turbine generates acoustic noise during operation. The acceptance of wind energy as a source of power may depend on the perceived level of noise disturbance. While the noise can be perceived to originate from the wind park as a whole, a specific wind turbine may also be identified as a contributor to the perceived noise. It is a known problem that a wind turbine blade design optimised for higher energy output of the turbine is also associated with an undesirably high level of acoustic noise. The noise emissions of a wind turbine could be reduced by providing the wind turbine with a smaller rotor blade diameter, i.e. by using shorter blades. In another approach, a lower rotational velocity could be used. The pitch angle of the blades of the wind turbine could also be altered, for example to face more steeply into the wind. However, all of these measures are directly related to a reduction in the energy efficiency of a wind turbine.

### SUMMARY OF INVENTION

Therefore, it is an object of the invention to provide a method of optimising a wind park construction to reduce the noise emissions of the wind park.

The object of the invention is achieved by the features of the independent claims.

According to the invention, a method of optimising the construction of a wind park, comprising at least a first wind turbine and a second wind turbine, comprises the steps of selecting a first blade topology for the first wind turbine based on a noise optimisation parameter which is measured and/or predicted at a reference position at a distance from the wind park, and selecting a second blade topology for the second wind turbine based on an energy efficiency optimisation parameter.

The construction of a wind park comprises the assembly and/or planning of a new wind park or the modification of an already operational wind park whose noise emission lies above a threshold, e.g. a threshold acceptable to the people living within acoustic range of the wind park. For planning purposes, the method according to the invention could be used for simulating the noise emissions, for example in form of simulation software running on a computer. In this way, the method according to the invention makes it possible to discover or determine an optimised wind park with an arrangement of wind turbines of the first and second type that keeps the noise emissions below a threshold.

A wind park according to the invention comprises at least a first wind turbine and a second wind turbine, wherein

a first blade topology is selected for the first wind turbine depending on a noise optimisation parameter which is measured and/or predicted at a reference position at a distance from the wind park, and

a second blade topology is selected for the second wind turbine depending on an energy efficiency optimisation parameter.

Accordingly, such a wind park comprises a plurality of first wind turbines and second wind turbines. The wind park is optimised in respect to energy efficiency while simultaneously maintaining the noise emissions below an established threshold. That means that the energy efficiency is maximised up to degree allowed by or compatible with the acceptable threshold for noise.

Particularly advantageous embodiments and features of the invention are defined in dependent claims, as revealed hereinafter. Features of the various embodiments described may be combined as appropriate.

A new wind park to be planned comprises a plurality of positions or sites for the wind turbines. The wind park to be planned could be provided with two types of wind turbines, e.g. wind turbines of a first type (referred to as “first wind turbines” in the following) and wind turbines of a second type referred to as “second wind turbines” in the following). The first wind turbines are optimised with respect to noise emissions and only generate a low level of noise. Accordingly, a first wind turbine has a blade topology associated with low noise emissions, and a corresponding low energy efficiency. The second wind turbine has a blade topology that is optimised with respect to energy efficiency. Accordingly, the total sum of power, e.g. the Annual Energy Production (AEP) is maximised for the second wind turbine. A second wind turbine therefore has a greater level of noise emission than a first wind turbine.

For each of the positions of wind turbines of the new wind park, one of the first or second wind turbines is chosen. The first wind turbine type is selected if the level of noise measured in an already operational wind park, or predicted in simulation for a planned wind park, exceeds a chosen threshold. The noise is measured or predicted in respect to a reference position at a distance removed from the wind park. That means that the reference position is outside of the wind park. The reference position could be the location of an inhabited area, for example a village or suburb. Accordingly, the wind park construction will be optimised in respect to noise disturbance at an inhabited area close to the wind park, e.g. to keep the noise disturbance below a threshold acceptable to the people living in that area. In this way, specific wind park locations are designated for wind turbines of the first type. For the remaining locations wind turbines of the second type are selected. This will lead to a wind park with a mixture of first and second wind turbines optimised with respect to the energy efficiency of the wind park as well as noise emission, whereby the noise disturbance will be kept below the acceptable threshold in a neighbouring inhabited area.

Further, the method could also be used for upgrading or modifying an already operational wind parks that has a noise emission which exceeds an acceptable threshold. It may be assumed in the following that such an already operational wind park comprises essentially only wind turbines of the second type, i.e. wind turbines that have been optimised with respect to their energy output, so that the already working wind part is only optimised in respect to energy efficiency. Upgrading may include a planning or simulation step before carrying out any actual amendments on the wind turbines of the wind park, in order to deter mine which of the second wind turbines have to be replaced by first wind turbines. In upgrading such a wind park, some second wind turbines are identified on the basis of their acoustic effect on the inhabited area and are replaced by wind turbines of the first type.

A wind turbine for a wind park according to the invention comprises a number of blades with trailing edges that can be optimized according to at least a first blade topology and a second blade topology, wherein the first blade topology relates to a noise optimisation parameter which is measured and/or predicted at a reference position at a distance from the wind park, and the second blade topology relates to an energy efficiency optimisation parameter. Accordingly, the first wind turbines and the second wind turbines differ only in respect to their blade topologies from each other. Therefore, it is possible to transform a wind turbine from the second type to a wind turbine of the first type, and vice versa, simply by amending or altering the blade topology.

A preferred embodiment of the wind turbine according to the invention is characterized in that the first blade topology defines a first shape of a trailing edge of a blade of the first wind turbine and the second blade topology defines a second shape of a trailing edge of a blade of the second wind turbine. Accordingly, only the shapes of the training edges of the blades will changed, whereby other parts of the blades and the wind turbine remain unchanged.

The noise emission of a wind turbine can be reduced by a serrated blade design. For example, the trailing edge could be realised with a serrated outer edge, and/or a serrated surface relief structure. The serrated design might be located on the lee-ward side of the blade. The serrated design might comprise a zig-zag outer edge over that part of the trailing edge in combination with a serrated relief pattern on the surface of that part of the trailing edge. The serrated design or pattern could extend along the entire length of the blade. In a preferred embodiment, however, the trailing edge is serrated only over a first part. Such a partial serrated design could be enough to reduce the noise emissions below a threshold level, while only decreasing the energy efficiency of the turbine to a relatively small degree. Therefore, it is not necessary to use blades with trailing edges serrated over their entire lengths or surfaces. Advantageously, therefore, the energy efficiency is only minimally affected by the noise optimisation of the blades.

To ‘convert’ a wind turbine from the second type to the first type, or vice versa, the blades of the wind turbine could be detached, removed, and replaced with blades of the other type. However, such a procedure can be time-consuming and costly. Therefore, in a particularly preferred embodiment of the invention the trailing edge of a blade comprises a first part and a second part. For example, a blade of a wind turbine of the second type can comprise a replacement part foaming a part of the trailing edge. The replacement part is detachably mounted on the blade. This part of the blade can be removed and replaced by a serrated replacement part, with a serrated design as described above that generates less noise emissions than the original essentially flat or non-serrated part. Such a blade design allows a wind turbine to be transformed from a second type to a first type, and vice versa, simply by exchanging the replacement parts of the blade trailing edges. A dismantling of the entire wind turbine and the construction of another is therefore not necessary. It is also not necessary to detach an entire blade from the hub, since only the replacement part of the blade need be detached and exchanged. A modification of an existing wind park to meet altered requirements with respect to noise thresholds can therefore be carried out in an uncomplicated and economical manner.

The energy efficiency of a wind turbine will increase with a higher lift-to-drag ratio. The lift-to-drag ratio is expressed as the effort required to turn the rotor blades of the wind turbine divided by the drag created by the blades as they move through the air.

In a further preferred embodiment of the invention, therefore, the first part of the blade is located in a region at the outermost end of the blade. Accordingly, the serrations are in the region of the blade tip. The velocity of a blade is highest at its tip, and therefore most of the noise is generated by the tip. Therefore, by arranging the serrations close to the tips of the blades, the noise generated by that wind turbine can be reduced most effectively without unduly worsening the lift-to-drag ratio.

In a further preferred embodiment, the first part extends over at most one third of the total length of the blade. This is an optimised trade-off between minimizing noise generation in the region of the blade tips and maximizing the energy efficiency of the wind turbine.

All parts of a blade could have the same degree of rigidity or stiffness. Generally, a stiff blade is preferred if the wind turbine is to be optimised with respect to its energy efficiency. However, a stiff trailing edge region may be associated with a higher level of noise. Therefore, in a further preferred embodiment, the first part is more flexible than the second part. The first part could be the region of the blade tip. Here, the blade tip could have a certain degree of freedom, for example freedom to oscillate. This reduces the noise generated at the blade tips.

### BRIEF DESCRIPTION OF THE DRAWINGS

Other objects and features of the invention will become apparent from the following detailed description considered in conjunction with the accompanying drawings. It is to be understood, however, that the drawings are designed solely for the purposes of illustration and not as a definition of limitations of the invention.

FIG. 1 shows a schematic representation of an embodiment of a wind park according to the invention;

FIG. 2 shows a schematic representation of an embodiment of a wind turbine of the first type,

FIG. 3 shows a schematic representation of an embodiment of a wind turbine of the second,

FIG. 4 shows a schematic representation of an embodiment of a blade wind turbine of the first type, and

FIG. 5 shows a schematic representation of an embodiment of a blade wind turbine of the second.

### DETAILED DESCRIPTION OF INVENTION

In the drawings, like reference numbers refer to like objects throughout. Objects in the drawings are not necessarily drawn to scale.

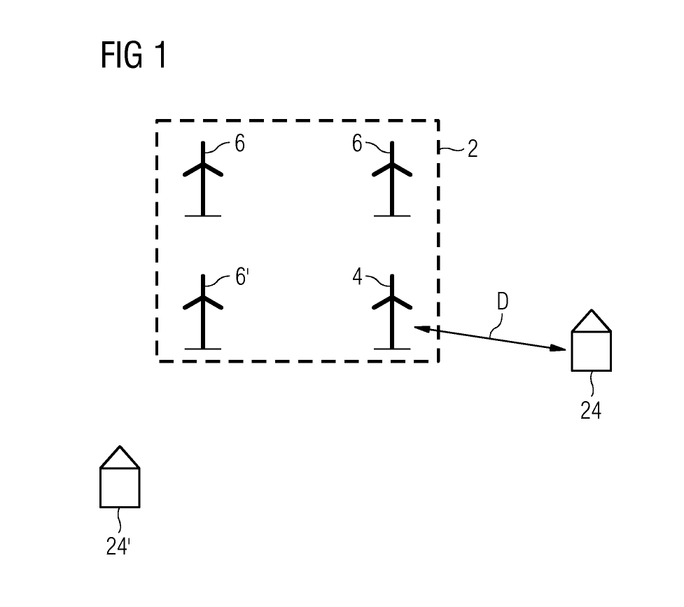

FIG. 1 shows an embodiment of a wind park 2 according to the present invention. The wind park 2 comprises four wind turbines 4, 6, 6′ of two types. The first wind turbine 4 of the first type is optimised in respect to low noise emissions, whereby the other second wind turbines 6, 6′ of the second type are optimised in respect to energy efficiency. That means that the second three wind turbines 6, 6′ have an optimised lift-to-drag ratio. A higher lift-to-drag ratio increases the energy efficiency of a wind turbine.

Outside of the wind park 2 is an inhabited area indicated by a house 24. As can be seen from FIG. 1 the first wind turbine 4 is at a position closest in respect to the house 24. Accordingly, at the position closest to the house 24 a first wind turbine 4 optimised in respect to low noise is arranged. This keeps the noise emissions, perceived in the inhabited area, below a threshold acceptable to the people living there. The remaining second wind turbines 6, 6′ are energy optimised. Therefore, the energy output of the wind park 2 is also as high as possible since only one of the wind turbines 4, 6, 6′ is a first wind turbine 4.

In the case of a new wind park 2 to be planned, the planning can commence with a virtual wind park 2 comprising only second wind turbines 6, 6′ at all positions. Then the noise will be estimated, for example by simulation, with respect to an inhabited area 24. In a next step, one of the second wind turbines 6, 6′ is identified according to its distance from the inhabited area 24 and will be replaced by a first wind turbine 4 as shown in FIG. 1. Subsequently, the altered noise level can be estimated. These steps of ‘replacing’ one or more noisy wind turbines by less noisy wind turbines can be repeated until the level of noise at the inhabited area 24 is estimated to lie below the threshold level.

A modification or alteration of a wind park 2 may become necessary if a second inhabited area or house 24′ is constructed close to the wind park 2, for example. To determine any necessary modifications, the noise is measured at the new house 24′. If the measured noise is above an acceptable threshold, suitable steps can be taken. For example, the second wind turbine 6′ closest to the new house 24′ can be altered to a wind turbine of the first type.

In the following the two types of wind turbines 4, 6 and the steps in their transformations are described in detail.

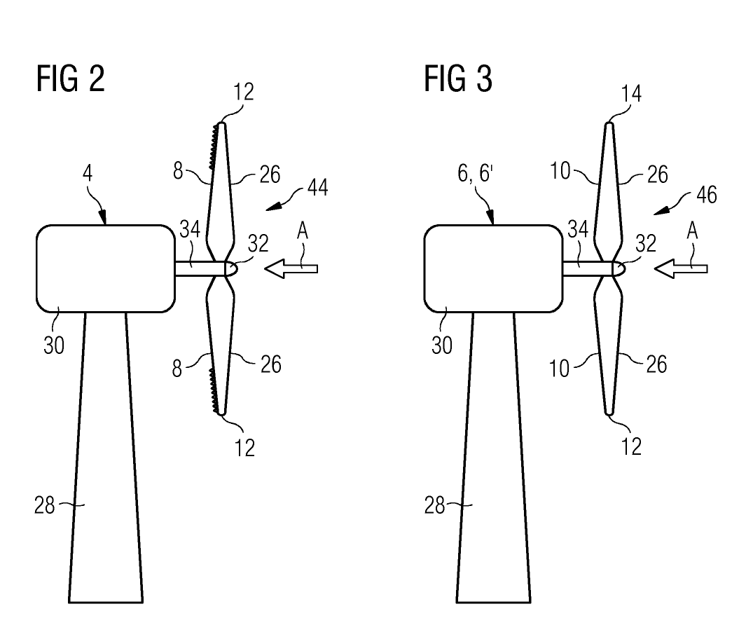

FIG. 2 shows an embodiment of the first wind turbine 4 according to the present invention.

The first wind turbine 4 comprises a tower 28, a nacelle 30 supported by the tower 28, and a hub 32 supported by the nacelle 30. Blades 12 are arranged on and fixed to the hub 32. Details regarding the usual operation of a wind turbine are not in the focus of the invention and will therefore not be described in detail hereinafter. Only those items, elements and systems that are relevant to the invention will be elucidated in the following description. The tower 28, the nacelle 30 and the hub 32 are conventional elements of the first wind turbine 4 and will therefore not be illustrated in more detail hereinafter.

The blades 12 have leading edges 26 and trailing edges 8. The leading edges 12 face into the direction A of air-flow before the trailing edges 8.

FIG. 3 shows an embodiment of the second wind turbine 6, 6′ according to the present invention. The second wind turbine 6, 6′ of FIG. 3 has the same tower 28, nacelle 30 and hub 32 of FIG. 1. Only the blades 14 of the second wind turbine 6, 6′ are different from the first wind turbine 4 of FIG. 2.

The blades 14 have leading edges 26 and trailing edges 10 as described above.

The blades 12 of the first wind turbine 4 have a first blade topology 44 which defines the shape of trailing edges 8. The blades 14 of the second wind turbine 6, 6′ have a second blade topology 46 which defines the shape of trailing edges 10.

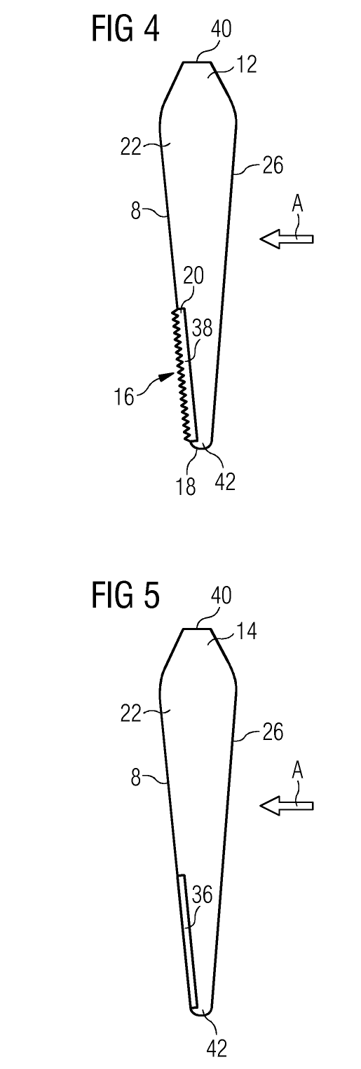

The differences of the blades 12 of the first wind turbine 4 and of the blades 10 of the second wind turbine 6 are now explained in detail with reference to the FIGS. 4 and 5.

It can seen from FIGS. 4 and 5 that both blades 12, 14 have a first end 40 with which the blades 12, 14 are mounted to the hub 32. A blade tip 42 as at the opposite or outermost end of the blade 26.

A blade 12, 14 is divided on its trailing edge 8, 10 in a first part 20, 36 and a second part 22. The first part 20, 36 extends over at most one third of the total length of the blade 12, 14, e.g. from the first end 40 to the blade tip 42. Accordingly, the second part 22 extends over two thirds of the length of the blades 12, 14.

The first part 20 of the blade 12 in FIG. 4 has a serrated design, in this example a saw-tooth edge, extending partly along the length of the blade 12. This saw-tooth pattern 16 reduces the generation of noise at the outermost end 18 of the blade 12 near the blade tip 42 where the noise generation is high due to the high velocity of the blade 14 at the blade tip 42.

In the first part 20 the trailing edge 8 of the first wind turbine 4 is formed by a serrated replacement part 38 with the saw tooth design 16. The serrated replacement part 38 is detachably mounted to the blade 8.

Further, the trailing edge 8 in the first part 20 of the blade 12 is more flexible compared to the trailing edge along the second part 22 of the blade. Therefore, this part of the blade 12 can oscillate with the blade tip 42 to further reduce the noise generated by that blade during operation of the wind turbine.

In contrast thereto, the blade 14 of the second wind turbine 6, 6′ comprises a replacement part 36 without such a serrated or saw-tooth design 16. The essentially flat replacement part 36 is detachably mounted to the blade 10. The replacement part 36 is associated with a favourably high lift-to-drag ratio and can therefore be used to optimise the energy efficiency of the wind turbine, but will result in a relatively high level of noise.

The detachable mounting of the replacement part 36 allows to remove the replacement part 36 from blade 12 of the second wind turbine 6, 6′ and to insert the serrated replacement part 36 instead, transforming the blade 12 to a blade 10. In this way, a wind turbine of the second type can be transformed quickly and economically to a wind turbine of the first type.

Although the present invention has been disclosed in the form of preferred embodiments and variations thereon, it will be understood that numerous additional modifications and variations could be made thereto without departing from the scope of the invention. For the sake of clarity, it is to be understood that the use of “a” or “an” throughout this application does not exclude a plurality, and “comprising” does not exclude other steps or elements.

1. A method of optimising a wind park construction, the wind park comprising at least a first wind turbine and a second wind turbine, the method comprising:
selecting a first blade topology for the first wind turbine depending on a noise optimisation parameter which is measured and/or predicted at a reference position at a distance from the wind park, and
selecting a second blade topology for the second wind turbine depending on an energy efficiency optimisation parameter.

2. The method according to claim 1, wherein the first blade topology defines a first shape of a trailing edge of a blade of the first wind turbine and the second blade topology defines a second shape of a trailing edge of a blade of the second wind turbine.

3. The method according to claim 1, wherein at least the trailing edge of the first wind turbine comprises a first part and a second part.

4. The method according to claim 3, wherein the trailing edge is serrated over the first part.

5. The method according to claim 4, wherein the first part is located in a region at the outermost end of the blade.

6. The method according to claim 5, wherein the first part extends at most one third of the total length of the blade.

7. The method according to claim 3, wherein the first part is more flexible than the second part.

8. The method according to claim 2, comprising a step of replacing a non optimized part with a replacement part, which is optimized according to the first or second topology.

9. The method according to claim 8, wherein the replacement part comprises a saw-tooth pattern.

10. A wind turbine for a wind park, comprising:
a plurality of blades with trailing edges which can be optimized according to at least a first blade topology and a second blade topology,
wherein the first blade topology relates to a noise optimisation parameter which is measured and/or predicted at a reference position at a distance from the wind park, and
wherein the second blade topology relates to an energy efficiency optimisation parameter.

11. A wind park, comprising:
a first wind turbine and a second wind turbine, wherein
a first blade topology is selected for the first wind turbine depending on a noise optimisation parameter which is measured and/or predicted at a reference position at a distance from the wind park, and
a second blade topology is selected for the second wind turbine depending on an energy efficiency optimisation parameter.
